(19) United States
(12) Patent Application Publication
(10) Pub. No.: US 2015/0272094 A1
(43) Pub. Date: Oct. 1, 2015

(54) "Smart" Semi-Autonomous Trawler Fishing Net

(71) Applicant: Lawrence Ahlfert Pearlman, Black Hawk, CO (US)

(72) Inventor: Lawrence Ahlfert Pearlman, Black Hawk, CO (US)

(21) Appl. No.: 13/999,893

(22) Filed: Apr. 1, 2014

(51) Int. Cl. A01K 73/04; A01K 73/02

(52) U.S. Cl. CPC A01K 73/04; A01K 73/025

(57) ABSTRACT

A system for reducing trawl bycatch through the use of a “flying”, “steerable” element of a towable or trawlerable fishing net, consisting of one or more hydrofoils at the mouth of the net, which maintains either a consistent height over the seabed or a pre-determined depth in the water, semi-autonomously. This negates the need, per the prior art in trawling and fishing technology, for heavy rollers on the bottom of the net, or heavy side “doors”. The present-day use of prior art ruins the ecosystem directly through physical damage to coral, sea bed hatcheries, etc., and indirectly by requiring increased fuel use on the trawling vessel and thus creating more emissions. This invention addresses those problems providing a better, cleaner and less destructive technology for fishing.

### FIELD OF THE INVENTION

The present invention relates to a system, apparatus and method for more efficient fishing, for reducing trawl bycatch, reducing environmental degradation of the seafloor and providing greater efficiency through a reduction in the weight of the net apparatus a trawler must pull through the water. It also allows better targeting of managed fish stocks.

### BACKGROUND OF THE INVENTION

The technology of trawl fishing has been heretofore concentrated on the reduction of bycatch through the use of passive systems such as turtle excluding devices (TEDs) and Bycatch Reduction Devices (BRDs) which while worthy, do not address the fundamental issues of environmental degradation caused by trawling across the seabed. The environmental degradation does not just include the destruction of underwater formations such as coral reefs, and the environment of demersal fish, but also skates and rays, and a multitude of spawn and juveniles species which spend formative early parts of their lifespan in the near vicinity of, or actually in, the seafloor. Present-day trawling fishing technology has not significantly advanced in the past decades apart from the increased use of electronic navigation (“GPS”, for example) and targeting devices (“Fishfinders”); trawling nets themselves remain heavy, destructive to the environment and primitive.

The invention, a net with one or more wing/hydrofoils embedded in the forward part of the net, “flies” itself just above the ocean floor or alternatively, at a predetermined depth in open water. This addresses the problem of marine environment degradation by enabling fishermen to accomplish their work without physically harming the seafloor, rocks, corals, fish hatcheries, etc. It also provides a sound business case for fishermen through the savings in fuel (because it is much lighter than a traditional trawling net, thus requiring less energy to pull through the water) compared to continued use of traditional, heavy, bottom trawling nets which use large “rockcrusher” rollers and heavy side “doors” to maintain their shape and their position on the seabed. In combination with present fishing technology such as fishfinders, the invention also allows active “steering” of the net towards only the desired fish stock. This reduces bycatch caused by indiscriminate trawling of non-specific, mixed, fish shoals, also known as area trawling. The invention may also incorporate data-logging which when downloaded (Or uploaded remotely) enables more precise fisheries management, furthering the sustainability of fisheries.

### SUMMARY OF THE INVENTION

According to the present invention, a system is provided which allows the fisherman or boat captain to set a desired height above the seafloor into the ‘smart’ sensing apparatus integrated into the net, and thus negates to need for heavy weights, rollers or wings. Alternatively, the apparatus may be instructed to maintain a desired depth in open water. The power required for this autonomous operation (The electricity needed for the embedded sensors in the hydrofoil, for the control panel onboard the vessel, and for the actuator which controls its “flight”) is negligible in industrial terms. Thus solar or wind power may be directly incorporated into the device, allowing for even smaller, less complex vessels (i.e. outboard, or even sail-driven) to use the invention. In addition, the controllability of the hydrofoils allows the fishing vessel captain to “steer” the net in a somewhat autonomous manner. This capability means that the net can be directed towards only those fish stocks which are allowed to be fished, reducing bycatch. Through datalogging, it may also provide a powerful fisheries management tool.

### BRIEF DESCRIPTION OF THE DRAWINGS

The invention will be described in detail through reference to the accompanying figures, in which:

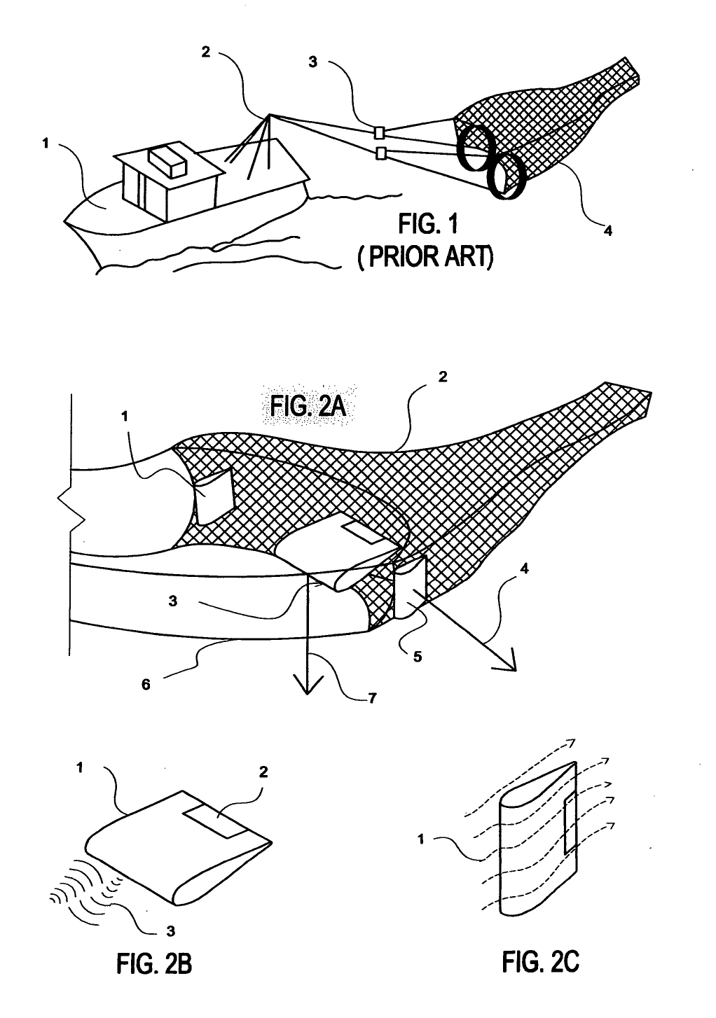

FIG. 1 A perspective view of prior art regarding fishing trawler nets.
1 Fishing vessel.
2 Net Attachment.
3 Net Lead Lines.
4 Trawler net.

FIG. 2A The Net part of the invention (A separate controller for the net is placed onboard the fishing vessel, not depicted).
1 Side Hydrofoil.
2 Body of net (Similar in design to prior art.
3 Bottom Hydrofoil.
4 Thrust vector of force pulling mouth of net out and open horizontally through sideways hydrodynamic “lift”.
5 Side hydrofoil.
6 Lead line.
7 Thrust vector of force pulling net mouth vertically through controllable hydrodynamic “lift”

FIG. 2B Close-up study of the controllable hydrofoil which maintains the vertical orientation of the net.
1 Body of hydrofoil that “flies” itself, and thus net, at specified depth or height above the seabed.
2 “Hydrovator” control surface integrated into trailing edge of hydrofoil.
3 Sonar/bottom sensor waves from sensor integrated into hydrofoil.

FIG. 2C Close-up study of a single side hydrofoil.
1 Dashed lines indicate the flow of water around hydrofoil shape, which in turn creates sideways “lift”, or more accurately, a thrust vector in the direction of the curved, outer, surface.

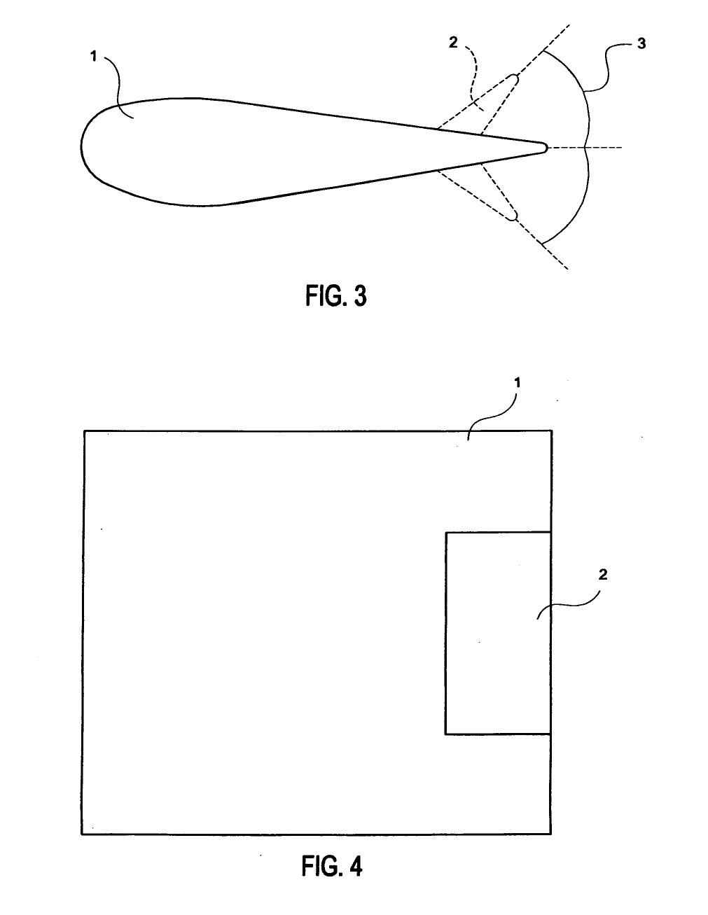

FIG. 3 A side view of a hydrofoil with control surface. Note how the hydrofoil is cambered, which provides a thrust vector in the direction of the more curved surface (In this case, the lower surface)
1 Hydrofoil is cambered, but provides sufficient interior volume for integrated control and sensing components.
2 “Hydrovator” control surface range of motion illustrated in this side view with dotted lines.
3 Arc indicates range of motion of “Hydrovator” control surface. As it moves up, the flow of water is also directed upwards, causing the hydrofoil, and the net to which it is attached, upwards. When the control surface moves down, the inverse occurs.

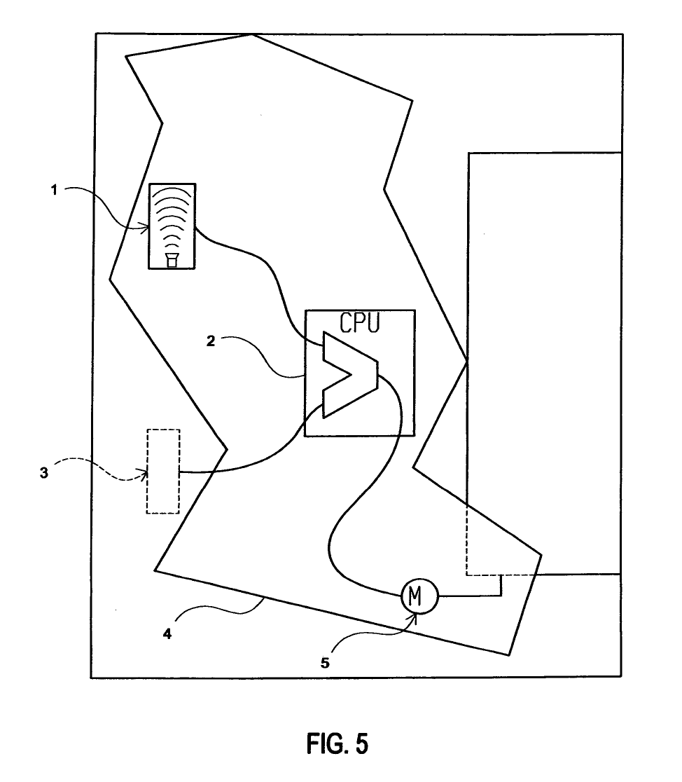

FIG. 4 Plan view of hydrofoil, to same scale as side view in FIG. 3, showing control surface integrated into trailing edge.
1 Depiction is a generic shape, in practice may have different chord ratio.
2 “Hydrovator” control surface at trailing edge of hydrofoil. In practice may also have a different chord/aspect ratio, and may even encompass entire trailing edge.

FIG. 5 Expanded, cut-away plan view of hydrofoil showing generic placement of interior components for purposes of illustration only.
1 Sonar (or similar) sensing unit integrated into hydrofoil leading area, used to determine height above seafloor and/or obstructions. May also be used in open water to directly search for desired fish stock.
2 Control unit (CPU) which takes information from sensors, user-operated control panel on vessel (Or pre-set instructions) and signals motor/actuator to achieve desired direction of hydrofoil(s) and thus net.
3 Second sonar unit, or alternatively depth meter or other sensor used to determine height above seafloor, depth in water, or direction towards desired fish stock. May also be a radio transceiver which can communicate with control panel onboard vessel.
4 Illustration cutaway line.
5 Motor/actuator for “Hydrovator” control surface.

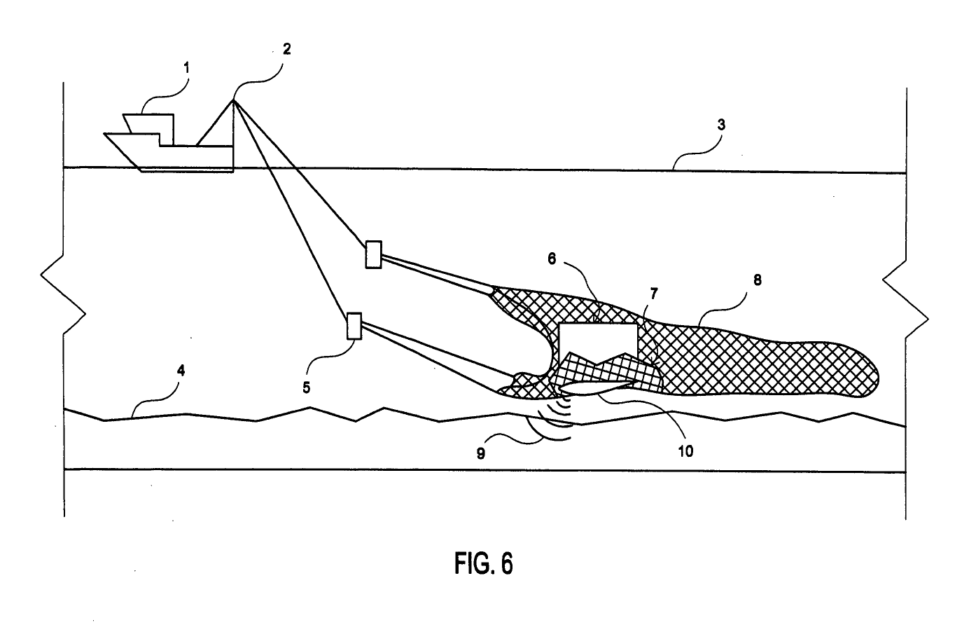

FIG. 6 Side view of invention, taken as a whole.
1 Trawler vessel which may have onboard control panel for directing depth or height above seabed of the net.
2 Mast/support for net, which may integrate a radio sending unit or alternatively a signal wire which runs down to the control unit of the controllable hydrofoil(s)
3 Water surface
4 Sea floor
5 Line weight/tie, which may incorporate a radio signal transceiver to enable communication between control panel onboard vessel and radio transceiver integrated into controllable hydrofoil. Alternatively signal wire splitter to control multiple controllable hydrofoils integrated into net.
6 Vertical side hydrofoil, partially cutaway to enable view of horizontal lower hydrofoil behind it.
7 Illustration cutaway line.
8 Body of net.
9 Sonar waves emitted by sensing unit in hydrofoil to determine depth above seafloor.
10 Lower, horizontal hydrofoil. Placement is generic, in practice, the hydrofoil may be incorporated at the very leading edge of the net mouth or further back, as depicted here.

### DETAILED DESCRIPTION

FIG. 1 illustrates the prior art fishing net. This “dumb” net uses heavy “rollers” to maintain contact with the seafloor and optionally heavy side “doors” (not depicted) to maintain horizontal shape and stability. Such a bottom-trawling net is extremely harmful to the sea floor environment, and has been implicated in destruction of coral, other natural formations, and fish (larval) hatcheries, among other adverse effects.

FIG. 2A is an isometric view of the invention. While the body of the net is similar in shape to prior art, the front is entirely different. Rather than heavy rollers and doors to maintain a given shape, the net mouth is held open through the physical integration of hydrofoils which, through the action of water flowing over them as the fishing vessel pulls them, form the desired net mouth shape either passively (Due to their shape as a lifting surface in accordance with Bernoulli's theorem), actively (Through the action of a “hydrovator” control surface), or from a combination of passive and active factors.

FIG. 2B is an isometric figure of the bottom hydrofoil. In this application only one hydrofoil is shown for purposes of clarity, but in practice multiple hydrofoils may be used along the front of the net, both above and below. To reiterate, for purposes of clarity, only one hydrofoil is shown here, depicting the foil shape, the control surface (“hydrovator”), and the sonar (Or similar) sensing unit which determines the height above the sea floor.

FIG. 2C is an isometric figure of a hydrofoil showing how the shape of the hydrofoil can, in accordance with Bernoulli's theorem, provide “lift”, or put another way, a thrust vector.

FIG. 3 is a side view of, in this instance, a bottom hydrofoil showing the generic shape of such a hydrofoil, and the movement and typical range of motion of the “hydrovator” control surface.

FIG. 4 is a plan view of a hydrofoil, showing a generic shape, and a generic type of “hydrovator” control surface, in this case integrated into the trailing edge. In actuality, the control surface may be incorporated at any point within the general hydrofoil shape. If “morphing” materials technology becomes viable, a separate control surface may not be needed at all, the entire hydrofoil changing its shape itself to provide upward or downward motion, as the case may be.

FIG. 5 is a cutaway plan view of a hydrofoil showing the elements integral to the invention. These include sensors, either of sonar, depthfinding type, or both. A control unit which interprets the operator's desired setting for either height above seabed, or absolute depth, takes information from the sensors and then instructs movement of the control surface through the motor/actuator.

FIG. 6 is a sideview of the invention in generic, simplified, form. The fishing vessel, connects to the net via lines. The net is in turn controlled by the hydrofoils, and maintains a set height above the seabed through the input from the sonar sensor, or at an absolute depth in the water through input from a depthmeter.

1. It is claimed that this system will directly reduce bycatch, prevent environmental damage to the seafloor caused by trawling, and reduce fuel use in trawlers through a ‘smart’ net which has semi-autonomous hydrofoils attached to the mouth of the net and which therefore does not need heavy rollers or wings to maintain its shape or placement on the sea floor. The ability to “steer” the net semi-autonomously, and for it to maintain its own position over the seafloor or its depth in the water mass independently, allows far more control over which fish are to be caught, reducing bycatch significantly. It is also claimed this invention will reduce the direct environmental impact of trawling (Since the net does not contact the seafloor directly is will not damage the sea floor topography in the way the current prior art does with its use of heavy “rockhopper” rollers and side “doors”). It is further claimed the invention will reduce fuel use since the weight of the net to be pulled is reduced, thus causing a reduction of the fishing vessel's contribution to greenhouse gas emissions. In summation, it is claimed:
a. A system according to claim 1, wherein the accurate placement of trawling nets near the sea floor, but not in contact, enables juvenile fish hatcheries to recover from damage caused by prior art trawl nets, and the sea floor topography to remain in an undisturbed state compared to the prior art.
b. A system according to claim 1, which enables reduction of bycatch through better control of nets in all trawling environments by setting net height for the specific depth at which a specific fish stock is found, or by “steering” the net semi-autonomously to the specific, desired, fish stock only .
c. A system for reduction of fuel use by fishing vessels in absolute terms through reduction in the overall weight and hydrodynamic effort needed of the net being trawled.
